(19) United States
(12) Patent Application Publication
(10) Pub. No.: US 2013/0103309 A1
(43) Pub. Date: Apr. 25, 2013

(54) EMERGENCY GUIDING SYSTEM AND SERVER

(71) Applicants: YI-WEN CAI, Tu-Cheng (TW); SHIH-CHENG WANG, Tu-Cheng (TW)

(72) Inventors: YI-WEN CAI, Tu-Cheng (TW); SHIH-CHENG WANG, Tu-Cheng (TW)

(73) Assignee: HON HAI PRECISION INDUSTRY CO., LTD., Tu-Cheng (TW)

(21) Appl. No.: 13/278,129

(22) Filed: Oct. 20, 2011

(51) Int. Cl. G01C 21/00

(52) U.S. Cl. 701/515

(57) ABSTRACT

An emergency guiding system includes an emergency guiding server and a portable device. The emergency guiding server includes a guiding scheme determination unit producing a guiding scheme in response to an emergency, a route providing unit producing a recommended route to reach a particular target according to the last guiding scheme and a device location information in a location signal in response to the production of the guiding scheme, and a scene location data unit including sets of scene location information. The portable device includes a location identification unit producing the device location information, which transmits the location signal including the device location information to the emergency guiding server. The emergency guiding server transmits a guiding signal including the recommended route to the portable device when the device location information corresponds to one set of the scene location information. The disclosure further provides an emergency guiding server.

### BACKGROUND

1. Technical Field

The present disclosure relates to an emergency guiding system and an emergency guiding server, and particularly to an emergency guiding system and an emergency guiding server capable of providing evacuation guidance through portable devices.

2. Description of Related Art

In a conventional emergency guiding system, evacuation guidance is provided through devices often immovably disposed along the evacuation pathway. In an emergency, evacuation guidance is provided through the devices such as indicator lights or speakers. However, in dense smoke, the indicator lights may not be seen and thus will not be able to act as guides for evacuees. In addition, other factors such as the layout and the density of the devices will influence evacuation guidance.

What is needed, therefore, is an emergency guiding system capable of overcoming the limitation described.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a block diagram of an embodiment of an emergency guiding system of the present disclosure.

FIG. 2 is a schematic view of an embodiment of the recommended route produced by the emergency guiding server of the emergency guiding system of FIG. 1.

FIGS. 3A, 3B, and 3C are schematic views of an embodiment displaying a route chart through the portable device of the emergency guiding system of FIG. 1.

FIG. 4 is a schematic view of another embodiment displaying a route chart through the portable device of the emergency guiding system of FIG. 1.

FIG. 5 is a schematic view of an embodiment displaying a warning message through the portable device of the emergency guiding system of FIG. 1.

### DETAILED DESCRIPTION

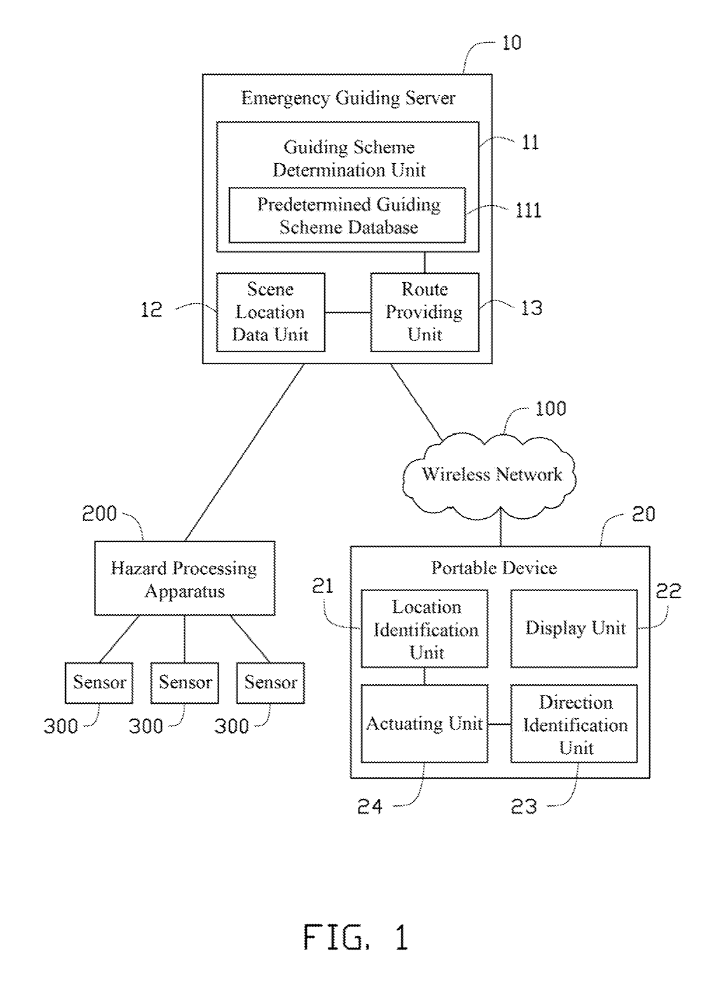

FIG. 1 is a block diagram of an embodiment of an emergency guiding system of the present disclosure. As shown in FIG. 1, an emergency guiding system includes an emergency guiding server 10 and a portable device 20. In the illustrated embodiment, the emergency guiding system is applied to emergency guidance during a fire hazard. In other embodiments, the emergency guiding system can be applied to other types of emergencies such as illegal entry. The emergency guiding server 10 communicates with the portable device 20 through a wireless network 100. The wireless network 100 is implemented according to a telecommunication standard such as Wi-Fi, Bluetooth, and GSM (Global System for Mobile Communications).

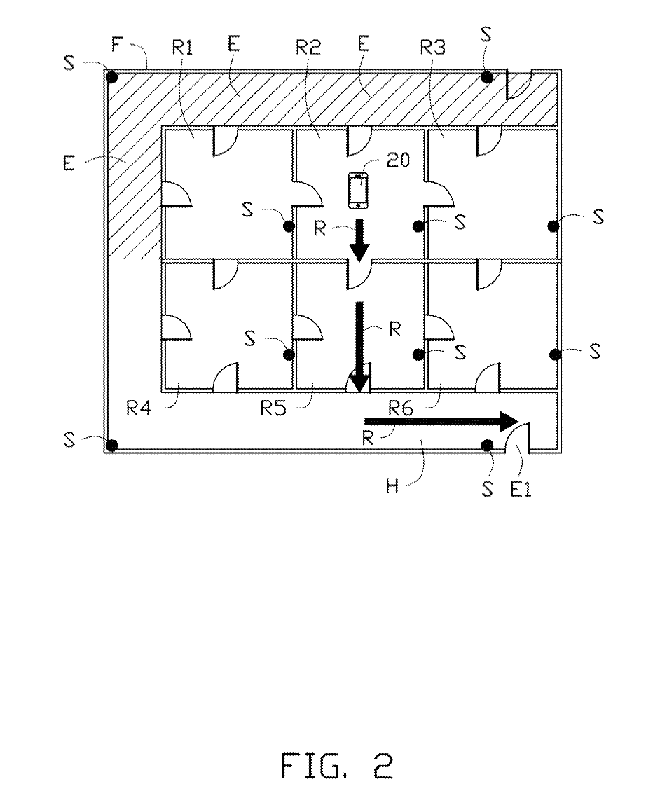

The emergency guiding server 10 includes a guiding scheme determination unit 11, a scene location data unit 12, and a route providing unit 13. The guiding scheme determination unit 11 produces a guiding scheme G (not shown) in response to the current status of an emergency area E of an emergency (see FIG. 2) such as a fire hazard or an illegal entry in real time. The scene location data unit 12 includes sets of scene location information Iₗ (not shown) each corresponds to one individual scene such as a room, a hallway, a floor plan, a carriage of a vehicle, a cabin of a ship, or other types of spaces. In the illustrated embodiment, the scene location data unit 12 is a database capable of inputting, storing, and outputting the scene location information Iₗ, while each set of the scene location information Iₗ includes a range of latitudes, longitudes, and elevations of individual scene for identifying the scope of the scene. In other embodiments, the scene location data unit 12 can be other types of data structure, while each set of the scene location information Iₗ can include a range of other types of location related parameters of individual scene. The emergency guiding server 10 receives a location signal Sₗ (not shown) from the portable device 20, wherein the location signal Sₗ includes device location information I_{d} of the portable device 20. The route providing unit 13 produces a recommended route R (see FIG. 2) to reach a particular target such as an exit, a place, or a fire apparatus in response to the production of the guiding scheme G. The recommended route R is produced according to the last guiding scheme G and device location information I_{d} in the location signal S₁ when the device location information I_{d} in the location signal Sₗ matches one set of the scene location information Iₗ in the scene location data unit 12. The emergency guiding server 10 transmits a guiding signal S_{g} (not shown) including the recommended route R to the portable device 20. In other embodiments, the emergency guiding server 10 can transmit the guiding signal S_{g} including a portion of the recommended route R adjacent to the portable device 20 according to the location signal S_{I}, while the range of the recommended route R (including the boundary and the detail of the recommended route R) transmitted to the portable device 20 is adjusted according to a route range signal Sᵣ (not shown) received from the portable device 20.

In the illustrated embodiment, the emergency guiding server 10 is alerted to the emergency in the emergency area E by an alarm signal Sₐ (not shown) received from a hazard processing apparatus 200 which is coupled to a plurality of sensors 300. The hazard processing apparatus 200 is a fire alarm control panel. The hazard processing apparatus 200 transmits the alarm signal Sₐ including status information Iₛ (not shown) of the actuated sensors 300 to the emergency guiding server 10 when the current status of the emergency area E is detected by the sensors 300. The guiding scheme determination unit 11 includes a predetermined guiding scheme database 111 including predetermined guiding schemes Gₚ (not shown) corresponding to the sensors 300. The predetermined guiding schemes Gₚ are guiding schemes determined in advance according to various possible scenarios of the kind of sensory data that might be received from the sensors 300 such as the location, the type, the detected parameters, and the actuation time of the sensors 300. Each of the predetermined guiding schemes Gₚ includes various sets of the status of the sensors 300 which are essential conditions in choosing the schemes, and the recommended route R. In other embodiments, the predetermined guiding schemes Gₚ can include the location of other objects related to the emergency such as fire apparatus. The guiding scheme determination unit 11 chooses one of the predetermined guiding schemes Gₚ as the guiding scheme G according to the status information Iₛ of the actuated sensors 300 in the alarm signal Sₐ. In other embodiments, the guiding scheme determination unit 11 can determine the guiding scheme G by other methods such as using a guiding scheme determination algorithm, instead of using the predetermined guiding scheme database 111. In addition, the emergency guiding server 10 can receive the alarm signal Sₐ directly from the sensors 300. Since the emergency guiding server 10 is alerted to the emergency by the alarm signal Sₐ which represents the real time status of the emergency in the emergency area E, the recommended route R can be produced in a dynamic manner and updated corresponding to the real time status of the emergency.

In the illustrated embodiment, the location signal S_{I} includes a location of the portable device 20. In other embodiments, the location signal Sₗ can include other parameters of the portable device 20. FIG. 2 is a schematic view of an embodiment of the recommended route produced by the emergency guiding server of the emergency guiding system of FIG. 1. As shown in FIG. 2, sensor icons S represent the sensors 300 disposed on the floor plan F. The scope with respect to the emergency, which is detected by the sensors 300 represented as the sensor icons S, is marked as the emergency area E. The recommended route R to an exit E₁ is represented by arrows.

The portable device 20 includes a location identification unit 21, a display unit 22, a direction identification unit 23, and an actuating unit 24. In the illustrated embodiment, the portable device 20 is a smart phone. In other embodiments, the portable device 20 can be other types of portable electronic devices such as feature phone, tablet computer, or notebook computer. In the illustrated embodiment, the location identification unit 21 is a GPS (Global Positioning System) receiver which produces the device location information I_{d} including a latitude, a longitude, and an elevation of the portable device 20. In other embodiments, the location identification unit 21 can be other types of devices such as WPS (Wi-Fi Positioning System) receiver, while the device location information I_{d} can include other types of location related parameters of the portable device 20.

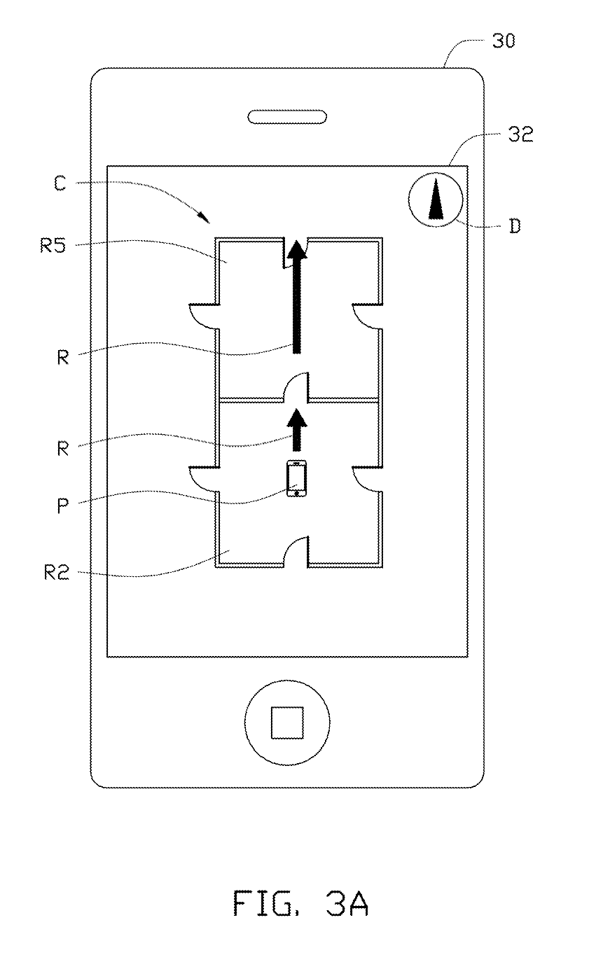

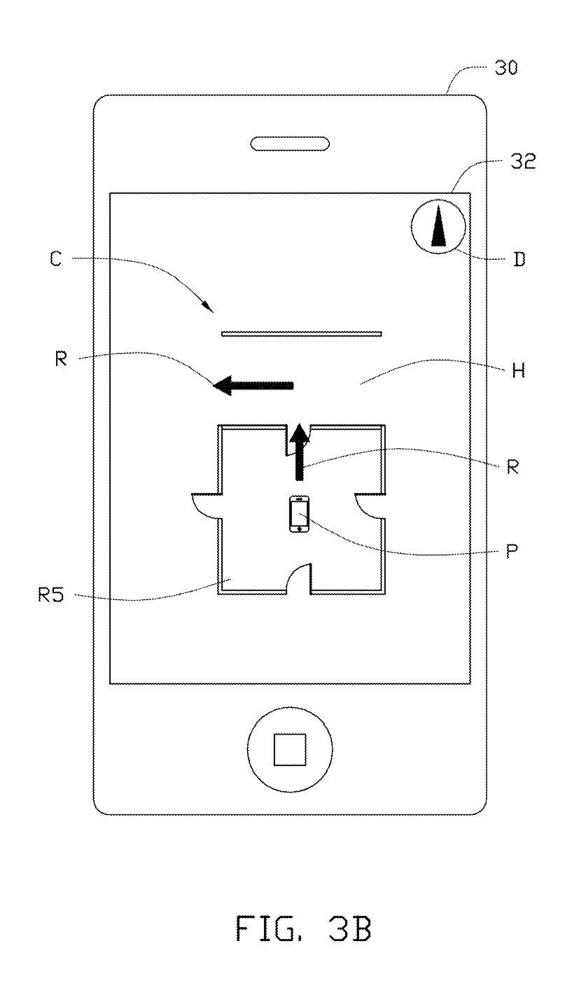

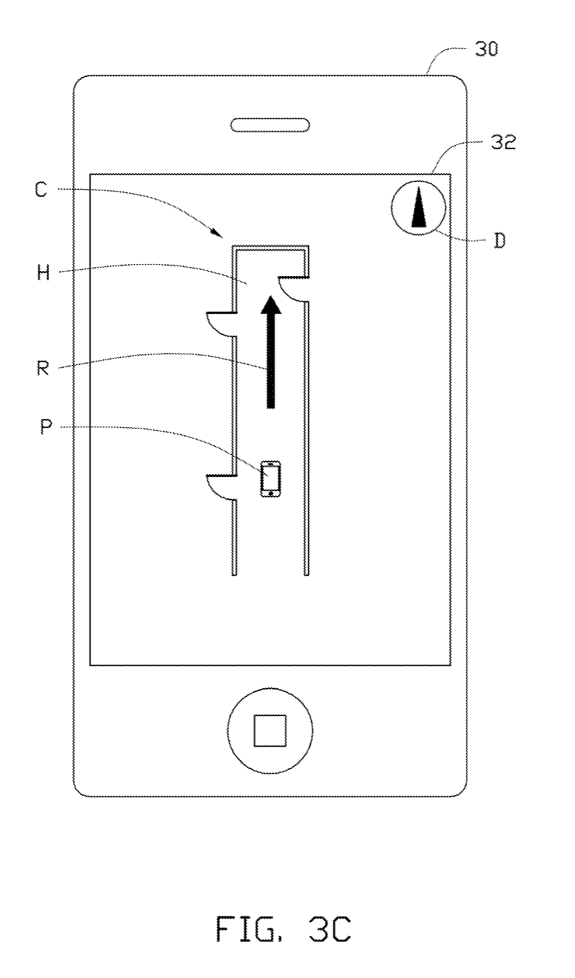

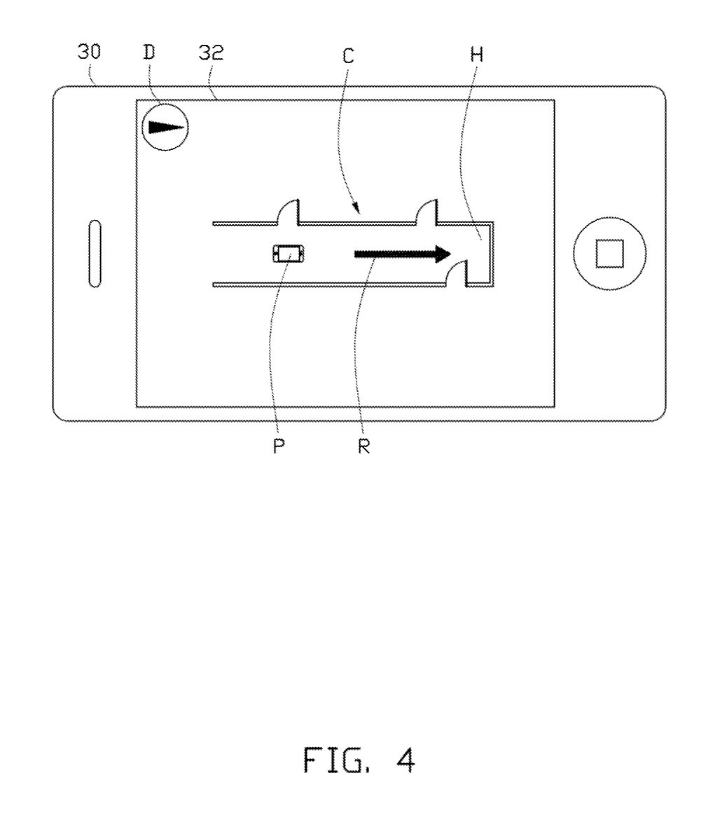

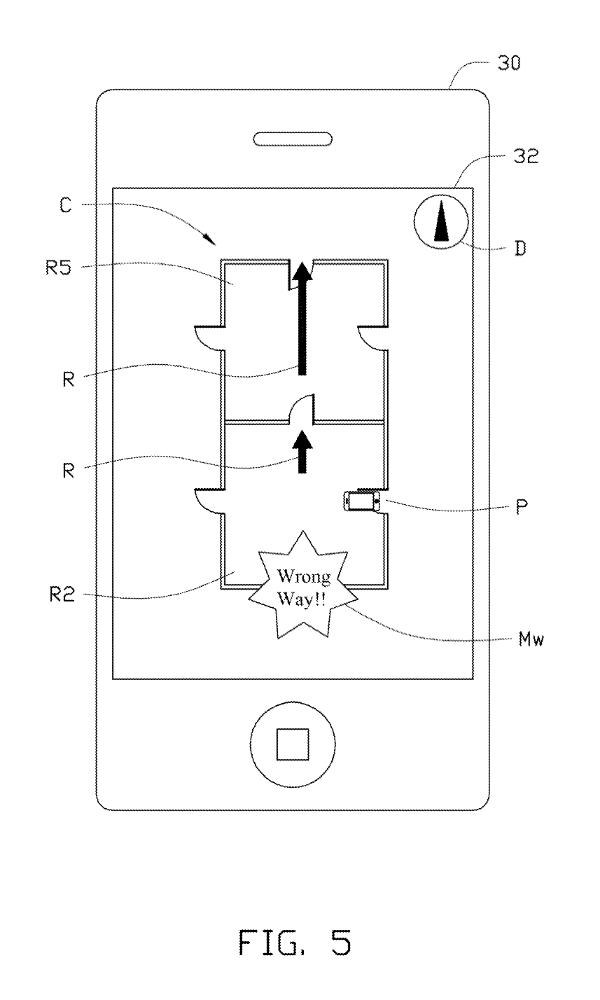

In the illustrated embodiment, the display unit 22 displays a route chart C (see FIG. 3A) including a portion of the recommended route R adjacent to the portable device 20 and a portable device icon P representing the location and the direction of the portable device 20, wherein the route chart C is produced according to the recommended route R in the guiding signal S_{g}. In other embodiments, the route chart C can be produced by the route providing unit 13 of the emergency guiding server 10, while the guiding signal S_{g} includes the route chart C instead of merely including the recommended route R. The range of the recommended route R displayed by the display unit 22 can be adjusted according to actual demands by, for instance, finger translation gestures with respect to the route chart C displayed on the display unit 22. The direction identification unit 23 determines a direction of the portable device 20. The direction identification unit 23 is a device such as electronic compass and magnetometer which is capable of determining Earth's magnetic field. FIGS. 3A, 3B, and 3C are schematic views of an embodiment displaying a route chart through the portable device of the emergency guiding system of FIG. 1. In the illustrated embodiment, as shown in FIGS. 3A, 3B, and 3C, the route chart C automatically rotates corresponding to the direction of the portable device 20, such that the direction to evacuate corresponds to the top side of the display unit 22. As shown in FIG. 3A, the route chart C displayed by the display unit 22 includes a portion of the recommended route R which is one unit of space adjacent to the portable device 20. Since the portable device 20, represented as the portable device icon P is in the room R₂, the route chart C includes a portion of the recommended route R which is in the room R₂ and the room R₅ adjacent to the room R₂. As shown in FIG. 3B, the portable device icon P is in the room R₅, so the route chart C includes a portion of the recommended route R which is in the room R₅ and a hallway H adjacent to the room R₅. As shown in FIG. 3C, the portable device icon P is in the hallway H, so the route chart C includes a portion of the recommended route R which is in the hallway H. In other embodiments, the direction of the route chart can be fixed to a particular direction corresponding to the scene of the emergency. FIG. 4 is a schematic view of another embodiment displaying a route chart through the portable device of the emergency guiding system of FIG. 1. As shown in FIG. 4, when the direction of the portable device 20 in FIG. 3A is turned counterclockwise, the direction of the route chart C is still corresponding to the actual direction of the scene of the emergency while that of the portable device icon P is also turned counterclockwise. In addition, as shown in FIGS. 3A, 3B, 3C, and 4, the display unit 22 further displays an indicator D to indicate the direction to evacuate according to the recommended route R. The display of the route chart C and the indicator D can be selectively enabled/disabled. FIG. 5 is a schematic view of an embodiment displaying a warning message through the portable device of the emergency guiding system of FIG. 1. As shown in FIG. 5, the display unit 22 of the portable device 20 displays a warning message M_{w} when the way which the portable device 20 moves not corresponds to the recommended route R in the guiding signal S_{g}.

In the illustrated embodiment, the actuating unit 24 such as an application software automatically enables the location identification unit 21 and the direction identification unit 23 in response to a triggering signal Sₜ (not shown) received from the emergency guiding server 10, and then directs the portable device 20 to transmit the location signal Sₗ to the emergency guiding server 10, wherein the emergency guiding server 10 produces the triggering signal Sₜ in response to the emergency. In other embodiments, the actuating unit 24 can automatically enable/disable other components of the portable device 20 which are necessary for the operation of the emergency guiding system. In addition, the portable device 20 can include a speaker unit such as phone speaker or loudspeaker, thereby providing audio guidance according to the recommended route R in the guiding signal S_{g}. The audio guidance can be provided through, for example, a phone call to drive the speaker unit.

The emergency guiding system utilizes a portable device to provide evacuation guidance according to the location of the portable device. In comparison with conventional emergency guiding systems which utilize devices immovably disposed at the scene of emergency to provide evacuation guidance, the guidance effect of the emergency guiding system is not liable to be influenced by dense smoke during a fire. In addition, since evacuation guidance are provided according to the location of the portable device and the real time status of the emergency, the emergency guiding system is capable of providing real time and more accurate evacuation guidance to the user of the portable device, while the time and the network bandwidth for transmitting the recommended route is saved by merely transmitting a portion of the recommended route adjacent to the portable device. Furthermore, since the display unit of the portable device merely displays the route chart which is a portion of the recommended route adjacent to the portable device, the user of the portable device can recognize the route to evacuate easily even when in a hurry, while the route chart has a smaller size and is more applicable to a portable device. Hence, the emergency guiding system is especially suitable for larger scenes such as skyscrapers or factory buildings.

While the disclosure has been described by way of example and in terms of preferred embodiment, it is to be understood that the disclosure is not limited thereto. To the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. An emergency guiding system, comprising:
an emergency guiding server including a guiding scheme determination unit, a route providing unit, and a scene location data unit, wherein the guiding scheme determination unit produces a guiding scheme in response to the current status of an emergency in real time, the scene location data unit includes at least one set of scene location information; and
a portable device including a location identification unit and communicating with the emergency guiding server through a wireless network, wherein the location identification unit produces a device location information, the portable device transmits a location signal including the device location information to the emergency guiding server;
wherein the route providing unit of the emergency guiding server produces a recommended route to reach a particular target according to the last guiding scheme and the device location information in the location signal in response to the production of the guiding scheme when the device location information in the location signal corresponds to one set of the scene location information in the scene location data unit of the emergency guiding server, the emergency guiding server transmits a guiding signal including the recommended route to the portable device.

2. The system of claim 1, wherein the emergency guiding server determines the current status of the emergency by an alarm signal received from a hazard processing apparatus coupled to a plurality of sensors, the hazard processing apparatus transmits the alarm signal including status information of the actuated sensors to the emergency guiding server in response to detecting the current status of the emergency through the sensors.

3. The system of claim 2, wherein the guiding scheme determination unit of the emergency guiding server includes a guiding scheme database including a plurality of predetermined guiding schemes corresponding to the sensors, the guiding scheme determination unit chooses one of the predetermined guiding schemes as the guiding scheme according to the status information of the actuated sensors in the alarm signal.

4. The system of claim 1, wherein each set of the scene location information include a first latitude, a first longitude, and a first elevation of individual scene, the device location information includes a second latitude, a second longitude, and a second elevation of the portable device.

5. The system of claim 1, wherein the portable device further includes a display unit, the portable device provides a route chart according to the recommended route in the guiding signal through the display unit.

6. The system of claim 5, wherein the route chart includes at least a portion of the recommended route adjacent to the portable device.

7. The system of claim 5, wherein the route chart automatically rotates corresponding to the direction of the portable device.

8. The system of claim 5, wherein the direction of the route chart is fixed to a particular direction corresponding to the scene of the emergency.

9. The system of claim 1, wherein the portable device further includes a speaker unit, the portable device provides an audio guidance according to the recommended route in the guiding signal through the speaker unit.

10. The system of claim 9, wherein the audio guidance is provided through a phone call.

11. The system of claim 1, wherein the portable device further includes a direction identification unit determining a direction of the portable device.

12. The system of claim 11, wherein the portable device provides a warning message when the direction not corresponds to the recommended route in the guiding signal.

13. The system of claim 1, wherein the portable device further includes an actuating unit, the emergency guiding server transmits a triggering signal to the portable device in response to the emergency, the actuating unit automatically enables the location identification unit and directs the portable device to transmit the location signal to the emergency guiding server in response to the triggering signal.

14. The system of claim 1, wherein the emergency guiding server transmits the guiding signal including at least a portion of the recommended route adjacent to the portable device to the portable device according to the device location information in the location signal, wherein the range of the recommended route transmitted to the portable device is capable of being adjusted according to a route range signal received from the portable device.

15. An emergency guiding server, comprising:
a guiding scheme determination unit producing a guiding scheme in response to the current status of an emergency in real time;
a scene location data unit including at least one set of scene location information; and
a route providing unit, wherein the route providing unit produces a recommended route to reach a particular target in response to the production of the guiding scheme, the recommended route is produced according to the last guiding scheme and a device location information in a location signal received from a portable device when the device location information in the location signal corresponds to one set of the scene location information in the scene location data unit of the emergency guiding server, and the emergency guiding server transmits a guiding signal including the recommended route to the portable device.

16. The server of claim 15, wherein the emergency guiding server determines the current status of the emergency by an alarm signal received from a hazard processing apparatus coupled to a plurality of sensors, the hazard processing apparatus transmits the alarm signal including status information of the actuated sensors to the emergency guiding server in response to detecting the current status of the emergency through the sensors.

17. The server of claim 16, wherein the guiding scheme determination unit includes a guiding scheme database including a plurality of predetermined guiding schemes corresponding to the sensors, the guiding scheme determination unit chooses one of the predetermined guiding schemes as the guiding scheme according to the status information of the actuated sensors in the alarm signal.

18. The server of claim 15, wherein each set of the scene location information include a first latitude, a first longitude, and a first elevation of individual scene, the device location information includes a second latitude, a second longitude, and a second elevation of the portable device.

19. The server of claim 15, wherein the emergency guiding server transmits a triggering signal to the portable device to enable an actuating unit of the portable device to enable the communication between the portable device and the emergency guiding server, and direct the portable device to transmit the location signal to the emergency guiding server.

20. The server of claim 15, wherein the emergency guiding server transmits the guiding signal including at least a portion of the recommended route adjacent to the portable device to the portable device according to the device location information in the location signal, wherein the range of the recommended route transmitted to the portable device is capable of being adjusted according to a route range signal received from the portable device.
